(19) United States
(12) Patent Application Publication
(10) Pub. No.: US 2026/0079698 A1
(43) Pub. Date: Mar. 19, 2026

(54) AI GATEKEEPER FOR SHARED CODE REPOSITORIES

(71) Applicant: Sony Interactive Entertainment Inc., Tokyo (JP)

(72) Inventor: Chockalingam Ravi Sundaram, San Mateo, CA (US)

(21) Appl. No.: 18/889,864

(22) Filed: Sep. 19, 2024

(51) Int. Cl. G06F 8/71; G06F 8/35; G06F 11/3668

(52) U.S. Cl. CPC G06F 8/71; G06F 8/35; G06F 11/3688

(57) ABSTRACT

Techniques are provided for configuring artificial intelligence (AI) components to prevent inadvertent commits of unlicensed code, prevent inadvertent violations of company code standards, policies, and licenses, to prevent inadvertent violations of code/library/dataset use, and to suggest alternative solutions for noted violations.

### FIELD

The present application relates generally to gatekeepers for shared code repositories and more particularly to the use of artificial intelligence (AI) to prevent commits of possibly violative code to code repositories.

### BACKGROUND

Code generation in large enterprises can pose complex and unwieldy management issues. For example, it is possible for unlicensed code to be copied and if committed to a code repository, violate restrictions on the code. As another example, it is possible for inadvertent violations of company code standards, policies, and licenses to creep into code. Yet again, inadvertent violations of code/library/dataset use may infect code.

### SUMMARY

Accordingly, an apparatus includes at least one processor system configured to input code from a coder computer to at least a license and policy (L&P) large language model (LLM). The processor system is configured to receive from the L&P LLM a first or second indication respectively indicating that the code complies with all of plural code rules and that the code does not comply with at least one of the code rules. Responsive to the first indication, the processor system is configured to commit the code to a code repository. On the other hand, responsive to the second indication, the processor system is configured to input the indication to at least a coder LLM and receive from the coder LLM model at least one alternative solution responsive to the second indication for implementation of the alternative solution in the code.

In some examples the processor system may be configured to automatically implement the alternative solution in the code. Or, the processor system may be configured to provide the alternative solution to the coder computer for implementation by the coder computer in the code.

In example implementations the processor system can be configured to receive the first or second indication from the L&P LLM at a gatekeeper LLM, and based on output from the gatekeeper LLM, commit the code to the code repository or input the second indication to the coder LLM.

In non-limiting embodiments the plural code rules may include one or more of proper indentation to ensure readability, naming convention for variables, functions and code file names, standardization of module headers, maximum number of characters in each line of code. In example embodiments the plural code rules may include one or more of use of a specific code library forbidden by at least one license, specific use of code forbidden by at least one license. If desired, information identifying licenses may be deleted from information provided to the L&P LLM.

In another aspect, an apparatus includes at least one processor system configured to input code from a coder computer to at least a first machine learning (ML) model and receive from the first ML model a first or second indication respectively indicating that the code complies with all of plural code rules and that the code does not comply with at least one of the code rules. The processor system is configured to, responsive to the first indication, commit the code to a code repository. In contrast, the processor system is configured to, responsive to the second indication, input the indication to at least a second ML model and receive from the second ML model at least one alternative solution responsive to the second indication for implementation of the alternative solution in the code.

In another aspect, a method includes training a machine learning (ML) assembly on ground truth code to recognize violations of one or more rules by the ground truth code. The method also includes, subsequent to training, input test code to the ML assembly. Responsive to the ML assembly indicating that the test code does not violate any of the one or more rules, the method includes committing the test code to a code repository. However, responsive to the ML assembly indicating that the code violates any of the one or more rules, the method does not commit the test code to a code repository.

The ML assembly may include a single large language model (LLM). Or, the ML assembly may include plural LLMs.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates overall logic in example flow chart format for an example architecture;

FIG. 3 illustrates additional logic consistent with FIG. 2;

FIG. 4 illustrates a first example artificial (AI) architecture for code commit;

FIG. 5 illustrates example training logic in example flow chart format for a first one of the LLMs shown in FIG. 4;

FIG. 6 illustrates example training logic in example flow chart format for a second one of the LLMs shown in FIG. 4;

FIG. 7 illustrates example training logic in example flow chart format for a third one of the LLMs shown in FIG. 4;

FIG. 8 illustrates a second example artificial (AI) architecture for code commit; and

FIG. 9 illustrates a third example artificial (AI) architecture for code commit.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

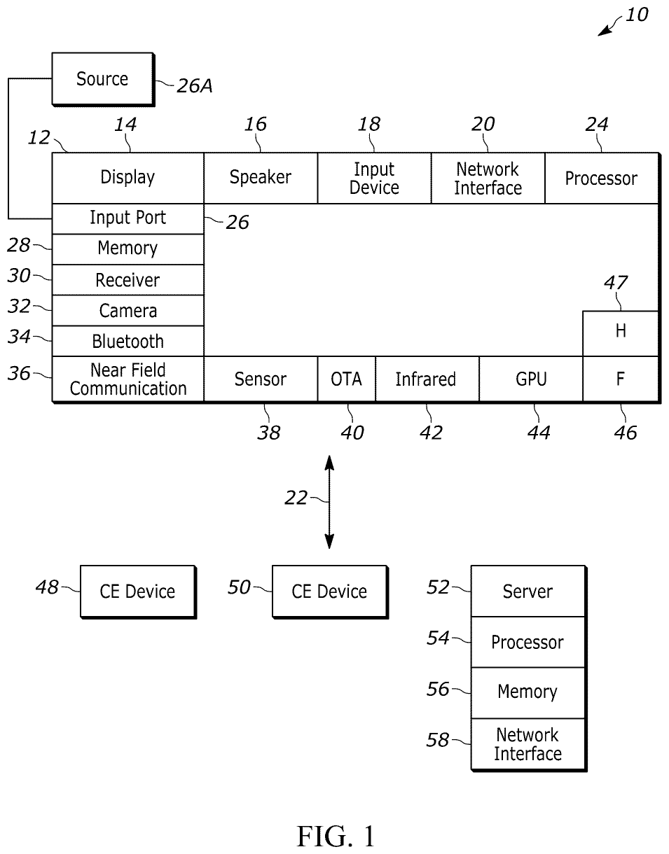

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

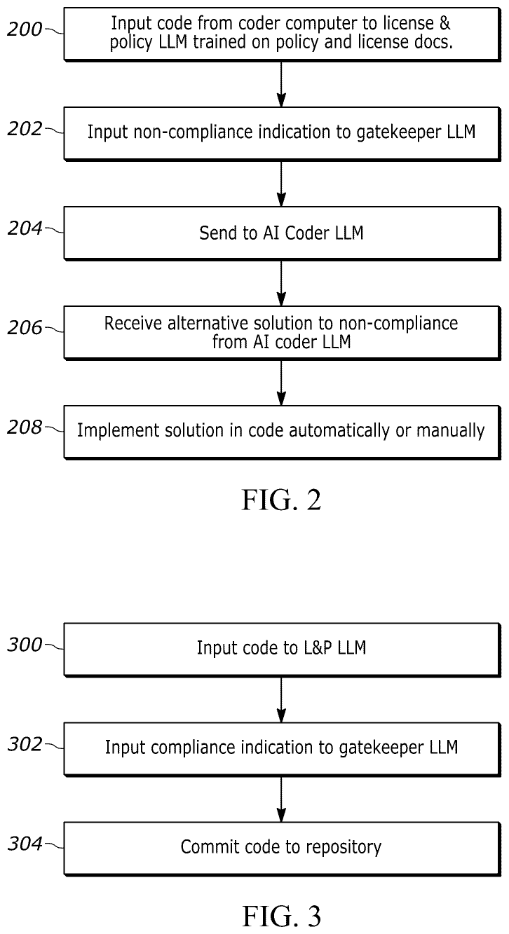

Refer now to FIG. 2. FIG. 2 illustrates logic to prevent unlicensed or policy-violating code commits by using one or more large language models (LLM) to ingest company code standards and policies and all licenses, determine violations of code/library/dataset use, and suggests alternative solutions for noted violations.

Commencing at state 200, code that is proposed to be committed to a code repository from a coder computer is input to a machine learning (ML) assembly, and in the embodiment shown, to a license and policy (L&P) large language model (LLM) that has been trained on licensing documents and code policy documents. Note that separate LLMs may be used, one for licensing documents and one for code policy documents.

Moving to state 202, any indication from the L&P LLM of non-compliance of the code whether by violating a license or a code policy (collectively, code rules) is input to a gatekeeper LLM, which sends the code to an artificial intelligence (AI) coder LLM at state 204. The AI coder LLM generates an alternative code solution or suggestion for the violating section of code which is received by the gatekeeper LLM at state 206. The alternative solution is implemented in the code automatically at state 208, or if desired is provided to a programmer for manual implementation into the code.

FIG. 3 illustrates that when code that is compliant with the code rules is input at state 300 to the L&P LLM which consequently inputs an indication of such to the gatekeeper LLM at state 302, the gatekeeper LLM commits the code to the repository at state 304.

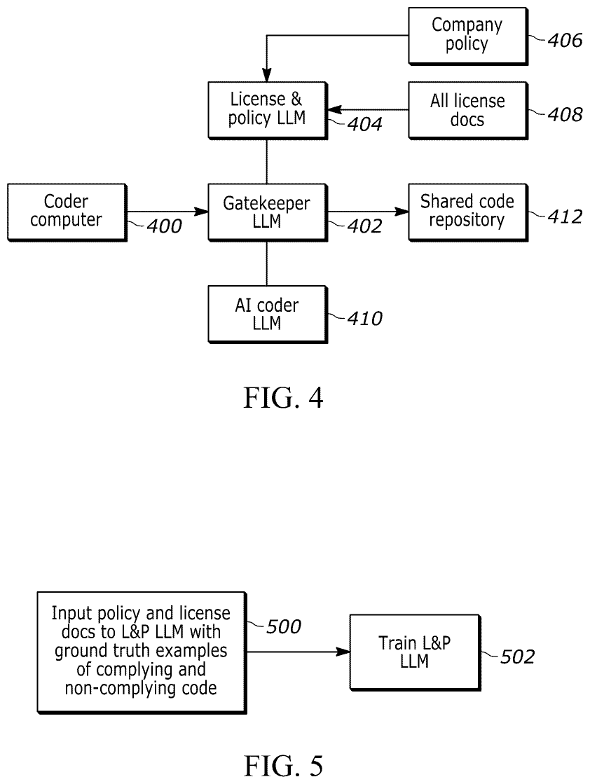

FIG. 4 illustrates a first example architecture consistent with present principles using terminology from FIGS. 2 and 3. A coder computer 400 inputs code to an L&P LLM 404, in the example shown through a gatekeeper LLM 402. The L&P LLM 404 communicates with a company policy document corpus 406 and a licensing document corpus 408. The gatekeeper LLM 402 also communicates with an AI coder LLM 410 to receive suggested corrections/solutions to non-complying code. The gatekeeper LLM 402 further communicates with a shared code repository 412 to commit complying code to the repository.

FIG. 5 illustrates logic for training the L&P LLM 404. Commencing at state 500, a training set of documents is input to the L&P LLM along with annotations/ground truth to train the L&P LLM at state 502. The training set may include license documents and company code policy documents along with ground truth examples of code that complies with the licensing and policy rules and ground truth examples of code that does not comply, e.g., by violating a non-commercial use license.

In greater amplification, training data can be found in license documents which are publicly available such as from websites that contain license details of all open source licenses. Codebases can be used to give the L&P LLM an understanding of the code to detect license violations. To train the LLM (or a separate LLM) to detect violations to company code standards, a code standards document set can be provided by the company in addition to the codebase as it also needs to have an understanding of the code.

Examples of code standards include proper indentation to ensure readability, naming convention for variables, functions and code file names for easy understanding, standardization of headers for all the modules in the codebase (headers might be name, description, date of creation, inputs, outputs etc.). Other examples might of code standards include a maximum number of characters in each line of code, comments expectation for crucial and complex lines of code, etc. Some of the coding standards are common across companies and some of them are company specific. The LLM (such as a single L&P LLM or a separate code standard-only LLM) ingests these standards and policies documents and can effectively determine if there is a violation of coding standards.

Note that subsequent to training, determining code standards can be done in multiple ways. Some code standards are specific and violations to these standards can be determined in a rule-based approach. For example, if a standard is that a code file should not exceed ‘x’ characters in a single line, a violation can be determined in a rule-based approach. However, as understood herein challenges arise when the code standard is a bit more abstract. For example, a code standard that code must be readable and easy to understand cannot be tested for using a definitive rule-based approach, so use of an LLM is advantageous. The LLM can also break down complex lines of code into simple easy to read lines of code.

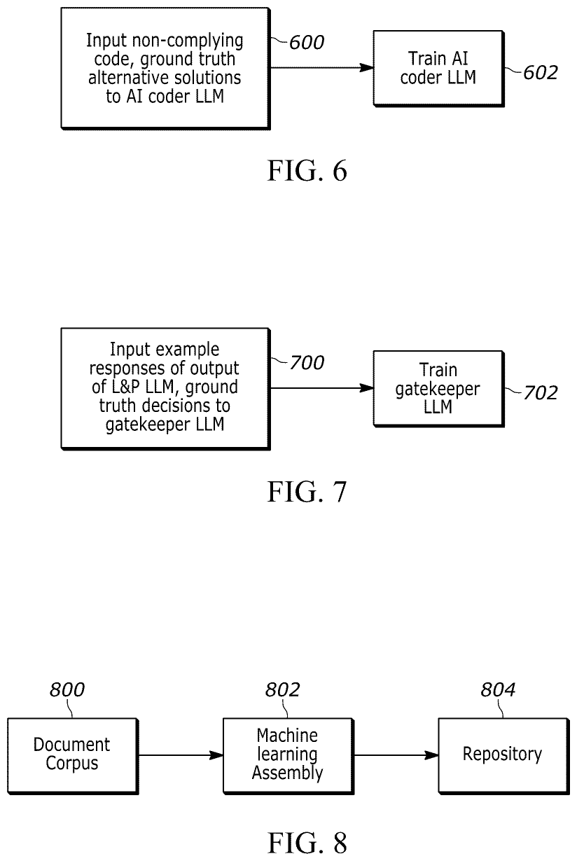

FIG. 6 illustrates example logic for training the AI coder LLM. A training set of data is input at state 600 to the AI coder LLM to train the LLM at state 602. The training set of data may include non-complying code with ground truth alternative solutions to the non-complying samples, along with code rule information if desired. The AI coder LLM subsequently generates solutions to non-complying code (e.g., in the form of a section of code that is compliant to replace the non-complying section) because it is trained on an equivalent library.

For example, the training set of data trains the AI coder LLM to auto correct code to match code standards (space between statements/modules, comments about modules required, some line-specific comments (complicated lines as indicted by number of computed logics or ML model mimics human understanding of what is complicated), naming of variables, naming of files). If desired, license-identifying information may be deleted from information provided to the LLMs. Plagiarism in code also may be detected.

FIG. 7 illustrates logic for training the gatekeeper LLM. A training set of data is input to the gatekeeper LLM at state 700 to train the LLM at state 702.

The training set of data may include example responses of outputs from the L&P LLM along with ground truth correct decisions as to whether to commit code to the repository based on the responses from the L&P LLM.

FIG. 8 illustrates a generic architecture consistent with present principles. A document corpus 800 (e.g., containing license and/or policy documents) can be accessed by an ML assembly 802 that can include one or more neural networks, such as LLMs. The ML assembly 802 thus may include only a single LLM, or it may include plural LLMs. The ML assembly determines whether to commit code to a repository 804 to avoid committing code that does not comply with company code standards or a license.

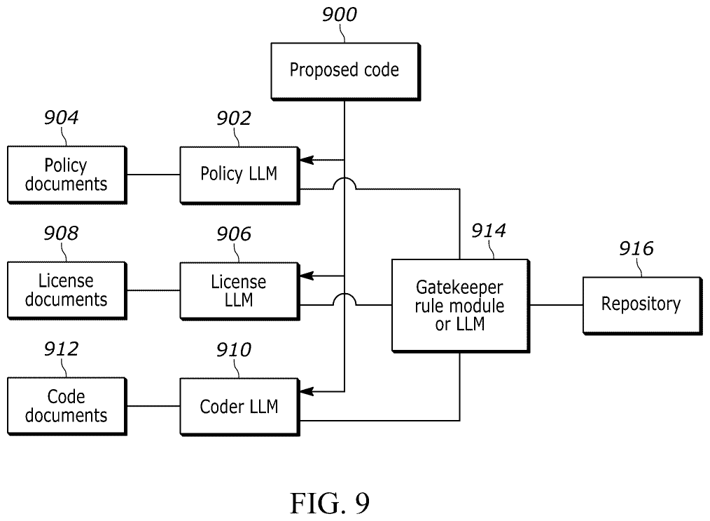

FIG. 9 illustrates a more complex architecture in which LLMs are specialized to specific document types to increase accuracy. Code 900 that is proposed to be committed to a repository is input to a policy LLM 902 to determine whether code complies with company coding policies as outlined in policy documents 904, a license LLM 906 to determine whether the code complies with license requirements/restrictions as indicated in license documents 908, and an AI coder LLM 910 to generate alternative suggested solutions to non-complying code as indicated in code documents 912. The LLMs 902, 906, and 910 communicate with a gatekeeper LLM 914 which decides whether to commit the code 900 to a repository 916 consistent with disclosure herein. Note that the proposed code 900 may be sent to the LLMs 902, 906, 910 through the gatekeeper LLM 914.

While the particular embodiments are herein shown and described in detail, it is to be understood that the subject matter which is encompassed by the present invention is limited only by the claims.

What is claimed is:

1. An apparatus comprising:
at least one processor system configured to:
input code from a coder computer to at least a license and policy (L&P) large language model (LLM);
receive from the L&P LLM a first or second indication respectively indicating that the code complies with all of plural code rules and that the code does not comply with at least one of the code rules;
responsive to the first indication, commit the code to a code repository;
responsive to the second indication, input the indication to at least a coder LLM;
receive from the coder LLM model at least one alternative solution responsive to the second indication for implementation of the alternative solution in the code.

2. The apparatus of claim 1, wherein the processor system is configured to:
automatically implement the alternative solution in the code.

3. The apparatus of claim 1, wherein the processor system is configured to:
provide the alternative solution to the coder computer for implementation by the coder computer in the code.

4. The apparatus of claim 1, wherein the processor system is configured to:
receive the first or second indication from the L&P LLM at a gatekeeper LLM; and
based on output from the gatekeeper LLM, commit the code to the code repository or input the second indication to the coder LLM.

5. The apparatus of claim 1, wherein the plural code rules comprise one or more of proper indentation to ensure readability, naming convention for variables, functions and code file names, standardization of module headers, maximum number of characters in each line of code.

6. The apparatus of claim 1, wherein the plural code rules comprise one or more of use of a specific code library forbidden by at least one license, specific use of code forbidden by at least one license.

7. The apparatus of claim 6, wherein information identifying licenses is deleted from information provided to the L&P LLM.

8. An apparatus comprising:
at least one processor system configured to:
input code from a coder computer to at least a first machine learning (ML) model;
receive from the first ML model a first or second indication respectively indicating that the code complies with all of plural code rules and that the code does not comply with at least one of the code rules;
responsive to the first indication, commit the code to a code repository;
responsive to the second indication, input the indication to at least a second ML model;
receive from the second ML model at least one alternative solution responsive to the second indication for implementation of the alternative solution in the code.

9. The apparatus of claim 8, wherein the processor system is configured to:
automatically implement the alternative solution in the code.

10. The apparatus of claim 8, wherein the processor system is configured to:
provide the alternative solution to the coder computer for implementation by the coder computer in the code.

11. The apparatus of claim 8, wherein the processor system is configured to:
receive the first or second indication from the first ML model at a third ML model; and
based on output from the third ML model, commit the code to the code repository or input the second indication to the second ML model.

12. The apparatus of claim 8, wherein the plural code rules comprise one or more of proper indentation to ensure readability, naming convention for variables, functions and code file names, standardization of module headers, maximum number of characters in each line of code.

13. The apparatus of claim 8, wherein the plural code rules comprise one or more of use of a specific code library forbidden by at least one license, specific use of code forbidden by at least one license.

14. The apparatus of claim 13, wherein information identifying licenses is deleted from information provided to the first ML model.

15. A method comprising:
training a machine learning (ML) assembly on ground truth code to recognize violations of one or more rules by the ground truth code;
subsequent to training, input test code to the ML assembly;
responsive to the ML assembly indicating that the test code does not violate any of the one or more rules, committing the test code to a code repository; and
responsive to the ML assembly indicating that the code violates any of the one or more rules, not committing the test code to a code repository.

16. The method of claim 15, comprising, responsive to the ML assembly indicating that the test code violates any of the one or more rules, generating using the ML assembly one or more suggested corrections to the test code.

17. The method of claim 16, comprising automatically changing the test code using the suggested corrections.

18. The method of claim 15, wherein the ML assembly comprises a single large language model (LLM).

19. The method of claim 15, wherein the ML assembly comprises plural LLMs.

20. The method of claim 19, wherein a first one of the LLMs outputs indications of whether the test code violates one or more rules and a second one of the LLMs outputs the suggested corrections.
